(19) United States
(12) Patent Application Publication
(10) Pub. No.: US 2015/0046607 A1
(43) Pub. Date: Feb. 12, 2015

(54) SEPARABLE PERIPHERAL DEVICE

(71) Applicant: Good Way Technology Co., Ltd., New Taipei City (TW)

(72) Inventors: YING-HAO LIN, NEW TAIPEI CITY (TW); HUNG-CHIH CHEN, NEW TAIPEI CITY (TW)

(73) Assignee: GOOD WAY TECHNOLOGY CO., LTD., New Taipei City (TW)

(21) Appl. No.: 13/964,302

(22) Filed: Aug. 12, 2013

(51) Int. Cl. G06F 13/38

(52) U.S. Cl. CPC G06F 13/385
USPC 710/30

(57) ABSTRACT

A separable peripheral device includes a first module and a second module. The first module includes first connection ports and a first processing unit. The first processing unit is connected to the first connection ports. The first processing unit executes a first algorithm and connects to at least two of the first connection ports. The second module includes second connection ports and a second processing unit. One of the second connection ports is connected to one of the first connection ports to receive a current and a data generated from one of the first connection ports. The second processing unit is connected to the second connection ports to receive the data. The second processing unit executes a second algorithm for converting the data. The second processing unit sends the converted data to one of the second connection ports.

### FIELD OF TECHNOLOGY

The present invention relates to electronic apparatus peripherals, and more particularly, to a multifunction separable peripheral device.

### BACKGROUND

According to the prior art, a computer apparatus has a limited number of input ports and output ports.

Today, computer apparatuses are equipped with an increasing number of peripheral electronic apparatuses, making their input ports and output ports insufficient. Accordingly, it is imperative to enable a computer apparatus with a limited number of input ports and output ports to be connected to multiple peripheral electronic apparatuses.

### SUMMARY

It is an objective of the present invention to provide a separable peripheral device which comprises a first module. The separable peripheral device is connected to a computer apparatus to increase the quantity of output ports and output ports of the computer apparatus.

Another objective of the present invention is to provide a separable peripheral device which comprises a second module. The first module is connected to the second module to expand the display function and networking function of the computer apparatus, for example.

Yet another objective of the present invention is to provide a separable peripheral device which comprises a power unit and/or a power module. One of the power unit and the power module of the separable peripheral device generates a current. The current is supplied to the first module and the second module.

In order to achieve the above and other objectives, the present invention provides a separable peripheral device which is connected to a first electronic device, a second electronic device, and/or a computer apparatus. The first electronic device and the computer apparatus each generate a data and/or a current. The separable peripheral device comprises a first module and a second module. The first module has a first connection port, a first communication port, a computer connection port, and a first processing unit. The first connection port is connected to the first electronic device. The computer connection port is connected to the computer apparatus. The first processing unit is connected to the first connection port, the first communication port, and the computer connection port. The first processing unit executes a first algorithm in order to be connected to at least two of the first connection port, the first communication port, and the computer connection port, so as to transmit the data between at least two of the first connection port, the first communication port, and the computer connection port. The computer connection port receives the current from the computer apparatus and transmits the current to the second processing unit. The second module has a second connection port, a second communication port and a second processing unit. The second communication port is connected to the first communication port. The second processing unit is connected to the second connection port and the second communication port. The second processing unit executes a second algorithm for converting the data from the second communication port into another data and sending it to the second connection port. The second communication port receives the current from the first communication port and transmits the current to the second processing unit.

### BRIEF DESCRIPTION

Objectives, features, and advantages of the present invention are hereunder illustrated with specific embodiments in conjunction with the accompanying drawings, in which:

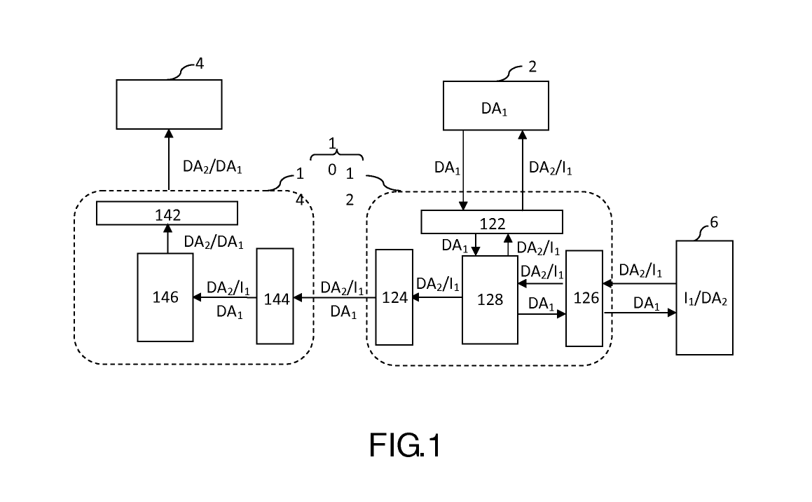

FIG. 1 is a schematic view of a separable peripheral device according to the first embodiment of the present invention;

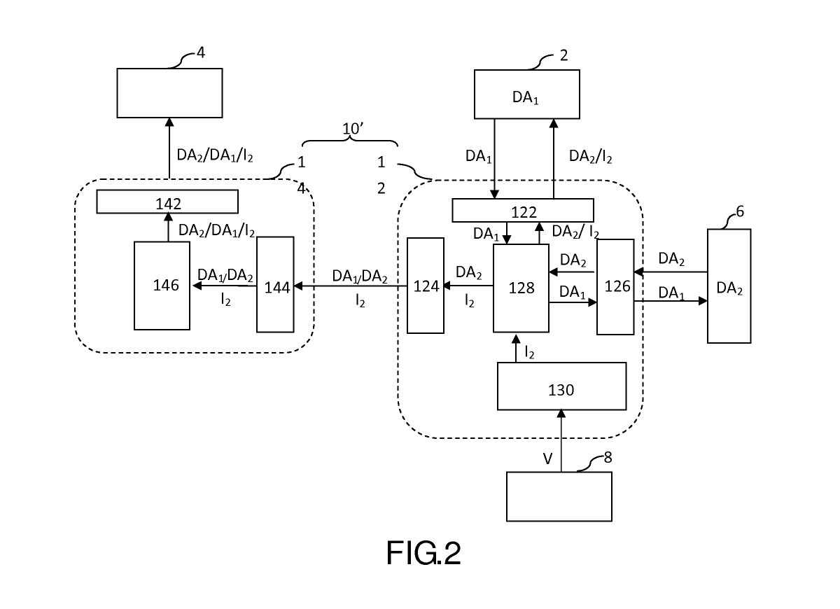

FIG. 2 is a schematic view of a separable peripheral device according to the second embodiment of the present invention;

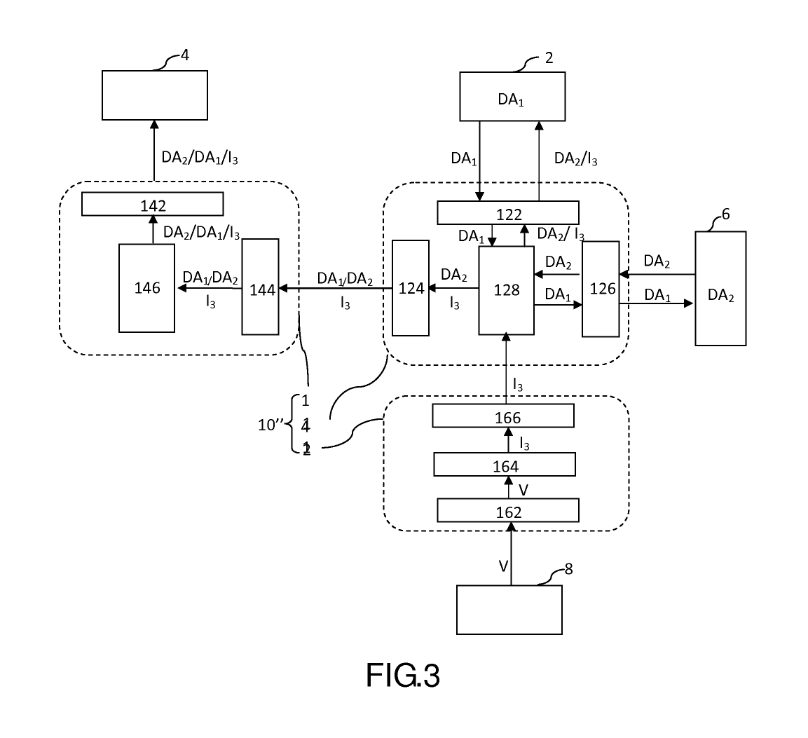

FIG. 3 is a schematic view of a separable peripheral device according to the third embodiment of the present invention; and

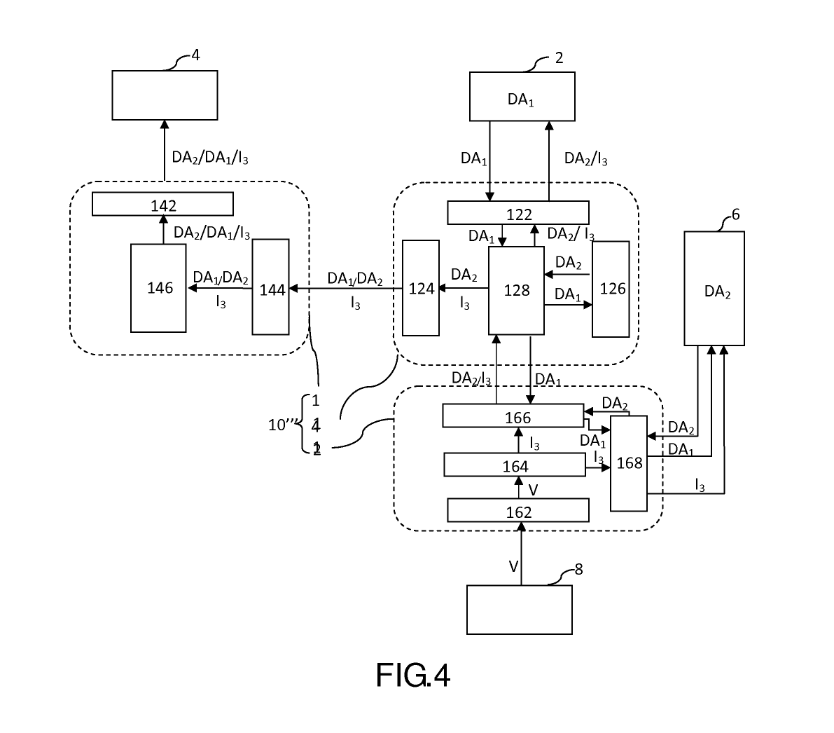

FIG. 4 is a schematic view of a separable peripheral device according to the fourth embodiment of the present invention.

### DETAILED DESCRIPTION

Referring to FIG. 1, there is shown a schematic view of a separable peripheral device according to the first embodiment of the present invention. As shown in FIG. 1, the separable peripheral device 10 is connected to a first electronic device 2, a second electronic device 4 and a computer apparatus 6. In this embodiment, the first electronic device 2 is exemplified by an external hard disk drive. The external hard disk drive stores a first data DA₁. The second electronic device 4 is exemplified by a display unit. The computer apparatus 6 generates a second data DA₂ and a first current I₁.

The separable peripheral device 10 comprises a first module 12 and a second module 14.

The first module 12 comprises a first connection port 122, a first communication port 124, a computer connection port 126, and a first processing unit 128.

The first connection port 122 is connected to the first electronic device 2 and adapted to receive the first data DA₁ from the first electronic device 2. For example, the first connection port 122 complies with a communication port protocol of IEEE 1394, universal serial bus (USB), micro-USB, mini-USB, and Apple 30 pins. The first connection port 122 not only transmits the first data DA₁ but also receives the second data DA₂ and the first current I₁ from the computer apparatus 6. In another embodiment, if the first electronic device 2 is a current storage apparatus (such as a power bank), the first connection port 122 receives a current from the first electronic device 2.

The first communication port 124 is connected to the second module 14. The computer connection port 126 is connected to the computer apparatus 6. Both the first communication port 124 and the computer connection port 126 comply with one of the aforesaid communication port protocols.

The first communication port 124 transmits the first data DA₁, the second data DA₂, and the first current I₁ to the second module 14. The computer connection port 126 receives the first current I₁ and the second data DA₂ from the computer apparatus 6. The first current I1 is supplied to the first processing unit 128. Furthermore, the computer connection port 126 generates and sends the first data DA₁.

The first processing unit 128 is connected to the first connection port 122, the first communication port 124, and the computer connection port 126. The first processing unit 128 executes a first algorithm (not shown) to determine whether to connect at least two of the first connection port 122, the first communication port 124, and the computer connection port 126. Given the aforesaid connection-related relationship, the first data DA₁ is sent to the first communication port 124 and/or the computer connection port 126, such that the second data DA₂ is sent to the first connection port 122 and/or the first communication port 124, whereas the first current I₁ is transmitted to the first connection port 122 and/or the first communication port 124.

The second module 14 comprises a second connection port 142, a second communication port 144, and a second processing unit 146.

The second connection port 142 is connected to the second electronic device 4. The second electronic device 4 receives the second data DA₂ from the second connection port 142 to thereby generate an image. For instance, the second connection port 142 complies with a video port protocol pertaining to a high definition multimedia interface, a digital video interface, a display port, and/or VGA.

In addition to the video port protocol, the second connection port 142 complies with one of the aforesaid communication port protocols in order to transmit any data other than the video data.

The second communication port 144 is connected to the first communication port 124 and adapted to receive the first data DA₁, the second data DA₂, and the first current I₁ from the first communication port 124. The first current I₁ is supplied to the second processing unit 146. To enable the first data DA₁ and the second data DA₂ to be transmitted between the second communication port 144 and the first communication port 124, it is necessary that the second communication port 144 and the first communication port 124 not only comply with the same communication port protocol but are also provided in the following form: if the connection port of the second communication port 144 is male, the connection port of the first communication port 124 is female, and vice versa.

The male connection port is bulgy, whereas the female connection port is receptive. The bulgy connection port is inserted into the receptive connection port to enable the second communication port 144 to be connected to the first communication port 124.

The second processing unit 146 is connected to the second connection port 142 and the second communication port 144. The second processing unit 146 executes a second algorithm (not shown) whereby the first data DA₁ and the second data DA₂ from the second connection port 142 are converted into the first data DAC and the second data DA₂′, respectively. Then, the second processing unit 146 sends the first data DAC and the second data DA₂′ to the second connection port 142.

In yet another embodiment, the data from the second communication port 144 is converted by the second processing unit 146 into a packet data which complies with an Ethernet protocol.

Referring to FIG. 2, there is shown a schematic view of a separable peripheral device 10′ according to the second embodiment of the present invention. The separable peripheral device 10′ comprises the first connection port 122, the first communication port 124, the computer connection port 126, and the first processing unit 128 in the first module 12 and the second connection port 142, the second communication port 144, and the second processing unit 146 in the second module 14 of the first embodiment. In the second embodiment, the first module 12 of the separable peripheral device 10′ further comprises a power unit 130. In the second embodiment, the computer apparatus 6 does not generate the first current Iᵢ.

The power unit 130 is connected to a power supply device 8, the first connection port 122, and the first communication port 124. A voltage V generated from the power supply device 8 is converted by the power unit 130 into a second current I₂. Then, the second current I₂ is transmitted by the power unit 130 to the first connection port 122 and the first communication port 124 and supplied to the first electronic device 2 and the second electronic device 4, respectively.

Referring to FIG. 3, there is shown a schematic view of a separable peripheral device 10″ according to the third embodiment of the present invention. The separable peripheral device 10″ not only comprises the first connection port 122, the first communication port 124, the computer connection port 126, the first processing unit 128, the second connection port 142, the second communication port 144, and the second processing unit 146 of the first embodiment, but also comprises a power module 16.

The power module 16 comprises a power input end 162, a power conversion unit 164, and a third communication port 166.

The power input end 162 is connected to a power supply device 8 and adapted to receive a voltage V generated from the power supply device 8.

The power conversion unit 164 converts the voltage V into a third current I₃ and transmits the third current I₃ to the third communication port 166.

The third communication port 166 is connected to the first communication port 124 and/or the second communication port 144 to thereby receive the third current I₃ from the third communication port 166. In a further embodiment, the third communication port 166 is connected to the first communication port 124 or the second communication port 144 to thereby receive the third current I₃ from the third communication port 166.

In a further embodiment, the power module 16 of the separable peripheral device 10″' comprises a fourth communication port 168, as shown in FIG. 4. The fourth communication port 168 is connected to the third communication port 166, the power conversion unit 164, and the computer apparatus 6. The third current I₃ from the power conversion unit 164 is sent by the fourth communication port 168 to the computer apparatus 6. The second data DA₂ from the computer apparatus 6 is sent by the third communication port 166 and the fourth communication port 168 to the first processing unit 128. The first data DA₁ is sent to the computer apparatus 6 via the third communication port 166 and the fourth communication port 168.

The present invention is disclosed above by preferred embodiments. However, persons skilled in the art should understand that the preferred embodiments are illustrative of the present invention only, but should not be interpreted as restrictive of the scope of the present invention. Hence, all equivalent modifications and replacements made to the aforesaid embodiments should fall within the scope of the present invention. Accordingly, the legal protection for the present invention should be defined by the appended claims.

What is claimed is:

1. A separable peripheral device connected to at least one of a first electronic device, a second electronic device, and a computer apparatus, wherein the first electronic device and the computer apparatus each generate at least one of a data and a current, the separable peripheral device comprising:
a first module having a first connection port, a first communication port, a computer connection port, and a first processing unit, the first connection port being connected to the first electronic device, the computer connection port being connected to the computer apparatus, the first processing unit being connected to the first connection port, the first communication port, and the computer connection port, the first processing unit executing a first algorithm and being connected to at least two of the first connection port, the first communication port, and the computer connection port so as to transmit the data between at least two of the first connection port, the first communication port, and the computer connection port, the computer connection port sending to the second processing unit the current received from the computer apparatus; and
a second module having a second connection port, a second communication port, and a second processing unit, the second communication port being connected to the first communication port, the second processing unit being connected to the second connection port and the second communication port, the second processing unit executing a second algorithm whereby the data from the second communication port is converted into another data and sending the another data to the second connection port, the second communication port sending to the second processing unit the current received from the first communication port.

2. The separable peripheral device of claim 1, wherein the first module comprises a power unit connected to a power supply device, the first connection port, and the first communication port and adapted to convert a voltage generated from the power supply device into a current and transmit the current to the first connection port and the first communication port.

3. The separable peripheral device of claim 1, further comprising a power module having a power input end, a power conversion unit, and a third communication port, the power input end being connected to a power supply device to receive a voltage from the power supply device, the power conversion unit converting the voltage into a current and transmitting the current to the third communication port, and the third communication port being connected to at least one of the first communication port and the second communication port.

4. The separable peripheral device of claim 3, wherein the power module comprises a fourth communication port connected to the third communication port, the power conversion unit, and the computer apparatus.

5. The separable peripheral device of claim 1, wherein the second processing unit executes the second algorithm whereby the data from the second communication port is converted into a video data which complies with a video protocol.

6. The separable peripheral device of claim 5, wherein the second connection port complies with a video port protocol pertaining to at least one of a high definition multimedia interface, a digital video interface, a display port, and VGA.

7. The separable peripheral device of claim 1, wherein the second processing unit executes the second algorithm whereby the data from the second communication port is converted into a packet data which complies with an Ethernet protocol.

8. The separable peripheral device of claim 7, wherein the second connection port complies with the Ethernet protocol.

9. The separable peripheral device of claim 1, wherein the first connection port, the first communication port, the computer connection port, the second connection port, and the second communication port each comply with a communication port protocol of IEEE 1394, universal serial bus (USB), micro-USB, mini-USB, and Apple 30 pins.
